(19) United States
(12) Patent Application Publication
(10) Pub. No.: US 2025/0027871 A1
(43) Pub. Date: Jan. 23, 2025

(54) ANTI-OXIDATION CONDITIONING SYSTEM WITH FUNCTION OF AUTOMATICALLY DISPLAYING AGING STATUS

(71) Applicant: ACE DRAGON CORP., Hsinchu County (TW)

(72) Inventor: Min-Jen TSAO, Hsinchu County (TW)

(21) Appl. No.: 18/635,350

(22) Filed: Apr. 15, 2024

(30) Foreign Application Priority Data
Jul. 20, 2023 (TW) 112127159
Jul. 20, 2023 (TW) 112207600

(51) Int. Cl. G01N 17/00; G08B 21/18

(52) U.S. Cl. CPC G01N 17/002; G08B 21/18

(57) ABSTRACT

An anti-oxidation conditioning system is operated with a function for automatically displaying aging status, and mainly includes a conditioning chamber device, at least one timing type environment parameter sensor, a computing device and a display. The conditioning chamber device is operated to control and keep a type of environment parameter of an anti-oxidation conditioning space falls in a control range. The timing type environment parameter sensor senses a plurality of sensed environment parameters in a plurality of sensing time defined by a sensing period respectively when the conditioning chamber device is operated. The computing device calculates an aging index representing aging status according to a degree of time change with respective to the sensed environment parameters deviate from the control range of a current statistic computing period with respect to a first statistic computing period. The display is disposed in the conditioning chamber device and displays the aging index.

This application claims the benefit of Taiwan Patent Application Serial No. 112127159, filed Jul. 20, 2023 and Serial No. 112207600, filed Jul. 20, 2023, the subject matter of which is incorporated herein by reference.

### BACKGROUND OF THE INVENTION

### Field of the Invention

The present invention is related to an anti-oxidation conditioning system, and more particularly is related to the anti-oxidation conditioning system with a function for automatically displaying aging status.

### Description of the Related Art

Some items or raw materials are very sensitive to environmental changes, once the environment changes, these items or raw materials will deteriorate or be damaged. Therefore, they need to be stored in a specific environment in order to preserve them for a longer period of time. In addition, for some products (such as electronic products), because they may need to be used in different climatic environments, they need to be placed in various test environments (including general test environments or extreme test environments) for a while to see if they can still function normally.

Because of the need to preserve the above-mentioned items or raw materials, as well as the need of environmental test for some products, environmental control systems and apparatuses emerged. Generally speaking, the environmental control system usually provides a space, controls at least one of the environmental parameters such as temperature, relative humidity, pressure, oxygen concentration, and luminous flux in the space, and thereby makes the space an environmental controlled space. if the controlled environmental parameters include relative humidity or oxygen concentration, the space becomes a controlled anti-oxidation conditioning space.

Specifically, the anti-oxidation conditioning system is usually equipped with at least one environmental parameter control module with a default or manually setting environmental parameter control range. Through the operation of the environmental parameter control module, the environmental parameters of the anti-oxidation conditioning space can be controlled in the environmental parameter control range so as to meet the storage needs of the above-mentioned items or raw materials as well as the needs of environmental test for some products.

Although most of the existing anti-oxidation conditioning systems are equipped with fault detection modules, which can automatically send an alarm message when a system fault is detected. The period from normal operation to system failure is an aging process occurs gradually over time. Because the existing technology lacks real-time monitoring for the aging process, when the anti-oxidation conditioning system malfunctions, the only way is to clear the fault as soon as possible.

In order to meet the need of troubleshooting in the shortest time, it is often necessary to prepare sufficient maintenance components or consumables, and to equip sufficient standby maintenance personnel or request cooperation partners to prepare sufficient significantly. However, such approach not only occupies a larger storage space for maintenance components or consumables, but also spends a higher maintenance labor cost.

In addition, when the anti-oxidation conditioning system ages to a certain extent, the operating efficiency of the environmental parameter control module often declines, which may need a higher energy cost in order to continue to keep the environmental parameters of the anti-oxidation conditioning space within the environmental parameter control range, such that the operating costs of the environmental control system would be increased, and the social responsibility of energy conservation and carbon reduction would not be fulfilled.

### BRIEF SUMMARY OF THE INVENTION

In view of the prior art which has the drawbacks such as a large storage space for storing maintenance components or consumables, a higher maintenance labor cost, increasing of operating cost of the environmental control system, and violation of social responsibility of energy conservation and carbon reduction, it is a main object of the present invention to provide an anti-oxidation conditioning system with the function of automatically displaying the aging status. The anti-oxidation conditioning system can regularly monitor and display the aging status of the anti-oxidation conditioning system by means of aging indexes. Thereby, the users of the conditioning system can have sufficient handling time to take appropriate processes to solve the above-mentioned problems before the failure occurs.

In order to solve the problems of the prior art, some embodiments of the present invention provide an anti-oxidation conditioning system with a function for automatically displaying aging status (hereinafter referred as the anti-oxidation conditioning system). The anti-oxidation conditioning system comprises a conditioning chamber device, at least one timing type environment parameter sensor, a data storage device, a computing device, and a display.

The conditioning chamber device has an anti-oxidation conditioning space for storing at least one object, and is used for adjusting an environment parameter of the anti-oxidation conditioning space during operation to keep the environment parameter within a control range. The timing type environment parameter sensor is disposed in the anti-oxidation conditioning space. Each timing type environment parameter sensor senses a plurality of sensed environment parameters in a plurality of sensing times defined by a sensing period respectively when the conditioning chamber device is operated. The data storage device is communicated with the timing type environment parameter sensor, for receiving and storing the plurality of sensing times and the plurality of corresponding sensed environment parameters.

The computing device has a computing program installed therein, is communicated with the data storage device for retrieving the plurality of sensing times and the plurality of corresponding sensed environment parameters from the data storage device, is set with the control range and a statistic computing period, and after executing the computing program, the computing device comprises an environment parameter comparison module and an aging index computing module.

The environment parameter comparison module is used for retrieving a deviation begin time and a maximum deviation time from the plurality of sensing times to access a maximum deviation time difference when determining that the plurality of sensed environment parameters begins to leave the control range and reaches a corresponding extreme value by sequential comparison, and retrieving a return time from the plurality of sensing times to access a return time difference when determining that the plurality of sensed environment parameters falls in the control range again from the corresponding extreme value by sequential comparison, wherein the process for accessing the maximum deviation time difference and the process for accessing the return time difference is defined as a deviation control cycle.

The aging index computing module receives m maximum deviation time differences and m return time differences corresponding to m deviation control cycles included in a first statistic computing period, receives n maximum deviation time differences and n return time differences corresponding to n deviation control cycles included in a most recently completed r^{th} statistic computing period, and when the plurality of sensed environment parameters of each of the deviation control cycles falls into the control range again, computes an initial exhaust rate of modulation capacity according to a first function, computes a current exhaust rate of modulation capacity according to a second function, and computes an aging index representing an aging status according to a third function. The display is disposed on the conditioning chamber device, and is communicated with the computing device for receiving and displaying the aging index.

The first function is ERmci=(Σᵢ₌₁^{m}Tbi)/(Σᵢ₌₁^{m}Tai); the second function is ERmcc=(Σⱼ₌₁ⁿTbj)/(Σⱼ₌₁ⁿTaj); and the third function is AI=(ERmcc−ERmci)/ERmci·100%.

Wherein, ERmci is corresponding to the initial exhaust rate of modulation capacity of the first statistic computing period; Tai is the maximum deviation time difference of i^{th} deviation control cycle in the first statistic computing period; Tbi is the return time difference of the i^{th} deviation control cycle in the first statistic computing period; ERmcc is corresponding to the current exhaust rate of modulation capacity of the r^{th} statistic computing period; Taj is the maximum deviation time difference of j^{th} deviation control cycle in the r^{th} statistic computing period; Tbj is the return time difference of the j^{th} deviation control cycle in the r^{th} statistic computing period; and AI is the aging index, the environment parameter includes relative humidity and oxygen concentration, and r, m, n, i, and j are natural numbers, wherein j is greater than or equal to 2.

In one preferred embodiment of the present invention, after executing the computing program, the computing device further comprises a first failure determination module and is set with an allowable return time ratio, wherein the first failure determination module is utilized for determining the conditioning chamber device is in an overtime deviation failure status when an overtime deviation failure condition is satisfied, so as to output an overtime deviation failure signal.

The overtime deviation failure condition is (Tfk)/(Tak)≥Kar; wherein Tak is the maximum deviation time difference of k^{th} deviation control cycle after finishing k−1^{th} deviation control cycle; Tfk is a continuous deviation time difference corresponding to the sensed environment parameters continuously staying outside the control range after the maximum deviation time difference of the k^{th} deviation control cycle; and Kar is the allowable return time ratio, and K is a natural number.

In one preferred embodiment of the present invention, after executing the computing program, the computing device further comprises a second failure determination module and is set with an allowable deviation amplification, wherein the second failure determination module comprises an average extreme value computing unit and a comparison determination unit.

The average extreme value computing unit is used for computing, after s deviation control cycles, an average environment parameter relative extreme value of the s deviation control cycles according to a fourth function. The comparison determination unit is used for determining the conditioning chamber device is in a severe deviation failure status when a severe deviation failure condition is satisfied, so as to output an severe deviation failure signal.

The fourth function is Pea=(Σₜ₌₁^{s}Pet)/S.

The severe deviation failure condition is |Pex−Pea|≥Kad; wherein, Pea is the average environment parameter relative extreme value; Pet is t^{th} environment parameter relative extreme value; Pex is an intensified deviation extreme value generated from the sensed environment parameters after reaching s+1^{th} environment parameter relative extreme value but is more deviated from the control range than the s+1^{th} environment parameter relative extreme value before returning to the control range; and Kad is the allowable deviation amplification, wherein s and t are natural numbers, and s is greater than or equal to 2.

In one preferred embodiment of the present invention, the anti-oxidation conditioning system further comprising an alarm device, the alarm device is communicated with the computing device for delivering a failure alarm signal when receiving the overtime deviation failure signal or the severe deviation failure signal. Preferably, the alarm device further comprises an alarm light or an alarm buzzer for generating an optical alarm signal or an audio alarm signal as the failure alarm signal.

In one preferred embodiment of the present invention, the anti-oxidation conditioning system further comprises a remote monitoring device, the remote monitoring device is communicated with the computing device for transmitting a failure notification message to notify a remote operator operating the remote monitoring device when receiving the overtime deviation failure signal or the severe deviation failure signal. In one preferable embodiment of the present invention, the anti-oxidation conditioning system further comprises a setting operation interface, wherein the setting operation interface is communicated with the at least one timing type environment parameter sensor and the computing device for setting the sensing period, the control range and the statistic computing period.

In one preferred embodiment of the present invention, the remote monitoring device can be a cell phone, a personal computer, a desktop computer, a tablet, or an industrial computer. In one preferable embodiment of the present invention, the timing type environment parameter sensor can be a timing type relative humidity sensor or a timing type oxygen concentration sensor. In one preferable embodiment of the present invention, the data storage device can be a near end data collector or a data storage server. In one preferable embodiment of the present invention, the computing device can be an embedded computer of the conditioning chamber device, an industrial computer, a personal computer, a laptop computer, or a computer server.

In conclusion, the anti-oxidation conditioning system with a function for automatically displaying aging status provided in the present invention uses the current exhaust rate of modulation capacity of the anti-oxidation conditioning system operating the most recently completed r^{th} statistic computing period and the initial exhaust rate of modulation capacity of the anti-oxidation conditioning system completing the first statistic computing period to execute the comparison computation so as to access the aging status of the anti-oxidation conditioning system after operating the most recently completed statistic computing period in comparison with that during the first statistic computing period, and presents the aging status on the display disposed on the conditioning chamber device in the form of aging index for a near end operator operating the conditioning chamber device such that the near end operator can handle the aging condition of the anti-oxidation conditioning system at any time. By using the aforementioned technologies, the near end operator can estimate residual modulation capacity and time left for maintaining normal operation, and access sufficient response time to prepare troubleshooting actions, such as making an appointment to perform maintenance or replace consumables by oneself or outsourcing.

From the above description, through the practice of the present invention, it is not needed to occupy a large storage space for storing maintenance components or consumables as well as to prepare a large number of standby maintenance personnel for troubleshooting, such that it can be further ensured that the antioxidant environment control system operates with reasonable performance and energy cost. There is no doubt that in compared with the prior art, the present invention can achieve the effects such as reducing the storage cost of maintenance components or consumables, reducing maintenance labor costs, reducing system operation costs, and fulfilling social responsibilities of “energy saving and carbon reduction”.

Further features of the present invention would be described in the following embodiments and figure.

### BRIEF DESCRIPTION OF THE DRAWINGS

FIG. 1 is a function block diagram showing an anti-oxidation conditioning system with a function for automatically displaying aging status provided in accordance with a preferred embodiment of the present invention.

FIG. 2 is a schematic view showing the relative position of the conditioning chamber device of the anti-oxidation conditioning system with a function for automatically displaying aging status provided in accordance with a preferred embodiment of the present invention and the surrounding related components when the conditioning chamber device is opened.

FIG. 3 is a schematic view showing the relative position of the conditioning chamber device of the anti-oxidation conditioning system with a function for automatically displaying aging status provided in accordance with a preferred embodiment of the present invention and the surrounding related components when the conditioning chamber device is closed.

FIG. 4 is a graph showing relative humidity versus time before and after the first deviation control cycle.

FIG. 5 is a graph showing relative humidity versus time of the first statistic computing period.

FIG. 6 is a graph showing relative humidity versus time of the second statistic computing period.

FIG. 7 is a graph showing relative humidity versus time when an overtime deviation failure status occurs after six deviation control cycles.

FIG. 8 is a graph showing relative humidity versus time when a severe deviation failure status occurs after six deviation control cycles.

### DETAILED DESCRIPTION OF THE EMBODIMENTS

Specific implementations of this disclosure are further described in detail below with reference to the accompanying drawings. According to the following descriptions and claims, the advantages and features of this disclosure are clearer. It should be noted that the drawings are drawn by using an extremely simplified form and imprecise proportion, which are only used for conveniently and clearly assisting in explaining the objective of the embodiments of this disclosure.

The anti-oxidation conditioning system with a function for automatically displaying aging status provided in the present invention can be widely applied to various existed anti-oxidation conditioning systems, which do not repeat herein but only one preferred embodiment is described in the following detailed description for explaining the purpose and effect of the embodiments of the present invention.

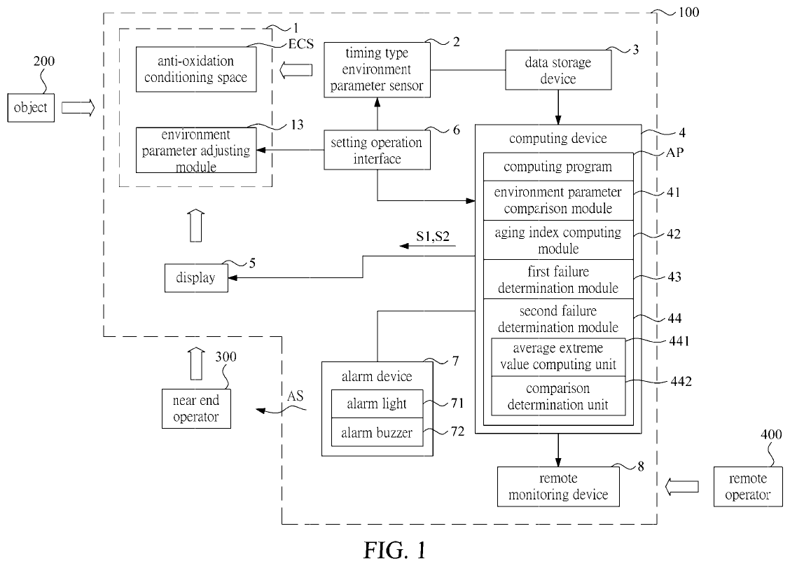

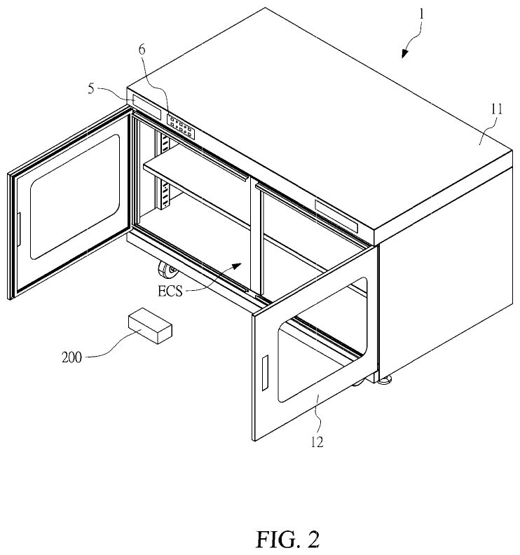

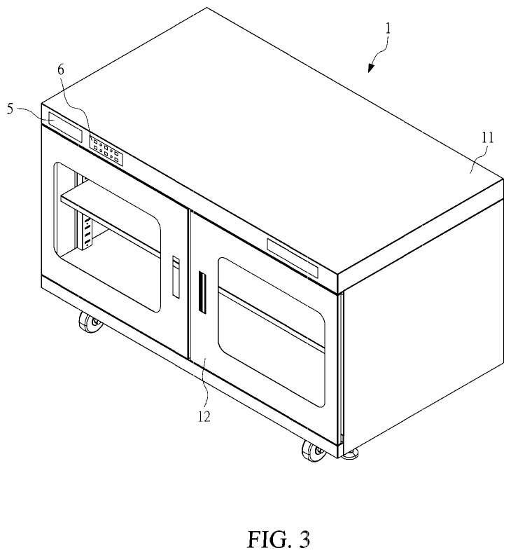

Please refer to FIGS. 1 to 3, wherein FIG. 1 is a function block diagram showing an anti-oxidation conditioning system with a function for automatically displaying aging status provided in accordance with a preferred embodiment of the present invention; FIG. 2 is a schematic view showing the relative position of the conditioning chamber device of the anti-oxidation conditioning system with a function for automatically displaying aging status provided in accordance with a preferred embodiment of the present invention and the surrounding related components when the conditioning chamber device is opened; and FIG. 3 is a schematic view showing the relative position of the conditioning chamber device of the anti-oxidation conditioning system with a function for automatically displaying aging status provided in accordance with a preferred embodiment of the present invention and the surrounding related components when the conditioning chamber device is closed. As shown in FIGS. 1 to 3, an anti-oxidation conditioning system 100 with a function for automatically displaying aging status (hereinafter referred as the anti-oxidation conditioning system), comprising a conditioning chamber device 1, one or plural timing type environment parameter sensor (only one timing type environment parameter sensor 2 is shown in the figures as a representative), a data storage device 3, a computing device 4, a display 5, a setting operation interface 6, an alarm device 7, and a remote monitoring device 8.

The conditioning chamber device 1 includes a chamber body 11, two chamber doors (only one of the chamber doors 12 is labelled), and an environment parameter adjusting module 13. When the chamber doors 12 cover the chamber body, an enclosed space is formed by the chamber body 11 and the chamber doors 12. After applying anti-oxidation control means to the enclosed space, the environment parameters of the enclosed space can be adjusted and kept within a control range using the environment parameter adjusting module 13 so as to have the enclosed space become an anti-oxidation conditioning space ECS for storing at least one object 200.

The anti-oxidation control means applied in the present invention can be the widely used relative humidity control means and oxygen concentration control means. Thus, the environment parameter adjusting module 13 can be the relative humidity adjusting module or the oxygen concentration adjusting module. Because the relative humidity adjusting module and the oxygen concentration adjusting module are widely used mature prior art, and are not the main technology feature of the present invention, the basic operation thereof is mentioned below with repeating the technology detail.

Take the relative humidity adjusting module for example, the relative humidity adjusting module usually comprises a dehumidification unit, a relative humidity sensor, and a controller operating with a fan and a valve. The dehumidification unit usually has moisture absorption balls, moisture absorption cotton or moisture absorption fabric. The controller usually sets a relative humidity range. When the controller determines that relative humidity of the anti-oxidation conditioning space ECS is high through the measurement of the relative humidity sensor, the controller may control rotation speed of the fan and on/off of the valve to introduce gas in the anti-oxidation conditioning space ECS, which has a higher relative humidity, into the dehumidification unit to remove moisture so as to generate the dry gas with a lower relative humidity. The dry gas is fed back to the anti-oxidation conditioning space ECS to lower down the relative humidity of the anti-oxidation conditioning space ECS. When the controller determines relative humidity of the anti-oxidation conditioning space ECS is low, the dehumidification unit and the fan may stop operation temporarily to save energy consumption. Meanwhile, the moisture absorption balls, the moisture absorption cotton or the moisture absorption fabric in the dehumidification unit may be dehumidified to restore part of the dehumidification ability.

Take the oxygen concentration adjusting module for example, the oxygen concentration adjusting module usually comprises a high-pressure gas bottle, an oxygen concentration sensor, and a controller operating with valves (or a compressed inflation mechanism, such as a compressed gas pump). The high-pressure bottle usually stores a high-pressure non-oxygen stable gas (the nitrogen is mentioned below for example). The controller usually sets an oxygen concentration range. When the controller determines that oxygen concentration of the anti-oxidation conditioning space ECS is high through the measurement of the oxygen concentration sensor, the controller may open one of the valves to exhaust gas in the anti-oxidation conditioning space ECS, which has a higher oxygen concentration, and open another valve to have high-pressure nitrogen injected into the anti-oxidation conditioning space ECS automatically through the pressure difference, or using the inflation mechanism to increase the pressure difference. With the increasing of nitrogen concentration, oxygen concentration of the anti-oxidation conditioning space ECS can be reduced.

However, whether the relative humidity adjusting module or the oxygen concentration adjusting module has its modulation capacity. For the relative humidity adjusting module, the modulation capacity is mainly decided by the amount of saturated water absorption of the moisture absorption balls, the moisture absorption cotton or the moisture absorption fabric in the dehumidification unit. After operating for a while, the moisture absorption balls, the moisture absorption cotton or the moisture absorption fabric in the dehumidification unit have absorbed some water. Even if some dehumidification ways such as heating dehumidification are performed to lower down the current amount of water absorption of the moisture absorption balls, the moisture absorption cotton or the moisture absorption fabric to restore part of the dehumidification ability, it is unpreventable for the dehumidification unit to lost some dehumidification ability. The current amount of water absorption divided by the amount of saturated water absorption can be regarded as a (current) exhaust rate of modulation capacity.

Attending with the increasing of the exhaust rate of modulation capacity increases, which implies the reduction of water absorption capability of the dehumidification unit, it would be needed to have the fan operated at a higher rotation speed to pump out more air to the dehumidification unit for performing dehumidification so as to have relative humidity back to the relative humidity range within a specific time period. As a result, the relative humidity adjusting module would need to consume more power for performing the adjustment function.

For the oxygen concentration adjusting module, the modulation capacity is mainly decided by the amount of nitrogen in the high-pressure gas bottle capable to be injected into the anti-oxidation conditioning space ECS. After operating for a while, some nitrogen is injected into the anti-oxidation conditioning space ECS, which may cause the high-pressure gas bottle to lose part of nitrogen. Thus, the current remaining amount of nitrogen capable to be injected into the anti-oxidation conditioning space ECS divided by the initial amount of nitrogen capable to be injected into the anti-oxidation conditioning space ECS can be regarded as another (current) exhaust rate of modulation capacity.

Attending with the increasing of the exhaust rate of modulation capacity increases, which implies the decreasing of pressure in the high-pressure gas bottle, it would be needed for the inflation mechanism to compress the gas using a higher power to inject sufficient nitrogen to the anti-oxidation conditioning space ECS so as to have oxygen concentration back to the oxygen concentration range within a specific time period. As a result, the oxygen concentration adjusting module would need to consume more power for performing the adjustment function.

The timing type environment parameter sensor 2 is disposed in the anti-oxidation conditioning space ECS. The so-called timing type environment parameter sensor 2 is a sensor regularly senses environment parameters by using a built-in timer or an external clock signal. Each timing type environment parameter sensor 2 is used to sense a plurality of sensed environment parameters of the anti-oxidation conditioning space ECS in a plurality of sensing times defined by a sensing period respectively when the conditioning chamber device 1 is operated. The timing type environment parameter sensor 2 can be a timing type relative humidity sensor or a timing type oxygen concentration sensor. In the present embodiment, the timing type environment parameter sensor 2 is the timing type relative humidity sensor.

The data storage device 3 is a near end data collector disposed in the conditioning chamber device 1 or a data storage server disposed at a remote end. The data storage device 3 is communicated with the timing type environment parameter sensor 2 for receiving and storing sensing times and corresponding sensed environment parameters (e.g., the sensed relative humidity parameters in the present embodiment).

The computing device 4 can be an embedded computer of the conditioning chamber device, an industrial computer, a personal computer, a laptop computer, or a computer server, has a computing program AP installed therein, and is communicated with the data storage device 3 for retrieving the sensing times and the corresponding sensed environment parameters from the data storage device 3. Meanwhile, the computing device 4 is also set with the aforementioned control range and a statistic computing period, and after executing the computing program AP, the computing device comprises a environment parameter comparison module 41, an aging index computing module 42, a first failure determination module 43, and a second failure determination module 44.

Because the environment parameter comparison module 41, the aging index computing module 42, the first failure determination module 43, and the second failure determination module 44 are generated after the computing program AP, substantially, the environment parameter comparison module 41, the aging index computing module 42, the first failure determination module 43, and the second failure determination module 44 can be regarded as a main program, a subroutine, a plug in of the computing program AP, or a derivative application program after executing the computing program AP.

The environment parameter comparison module 41 is used for retrieving a deviation begin time and a maximum deviation time from the plurality of sensing times to access a maximum deviation time difference when determining that the sensed environment parameters begin to leave the control range and reach a corresponding extreme value by sequential comparison. The environment parameter comparison module 41 retrieves a return time from the plurality of sensing times to access a return time difference when determining that the sensed environment parameters fall in the control range again from the corresponding extreme value by sequential comparison. The aforementioned processes are defined as a deviation control cycle.

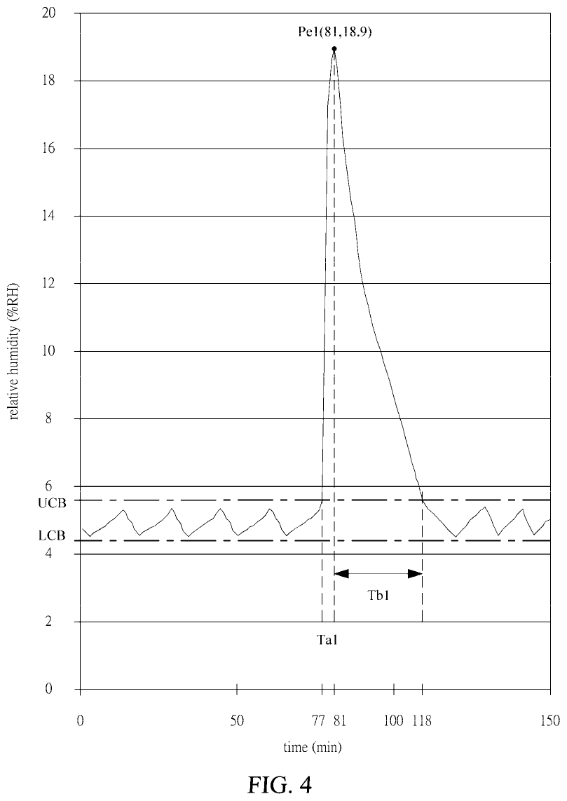

Please refer to FIG. 4, which is a graph showing relative humidity versus time before and after the first deviation control cycle. As shown in FIG. 4, in the present embodiment, the timing type environment parameter sensor 2 senses one sensed relative humidity parameter every one minute. That is, the first sensed relative humidity parameter is sensed in the first minute, and after the conditioning chamber device 1 begins operating for 150 minutes, 150 corresponding sensed relative humidity parameters are generated.

In the present embodiment, the control range is the relative humidity control range from the lower control boundary value LCB (4.6% RH) to the upper control boundary value UCB (5.3% RH). At 77^{th} minute of the comparison, because the chamber door 12 (labelled in FIG. 1) is opened, the sensed relative humidity parameters begin to be greater than the upper control boundary value UCB. Thus, the 77^{th} minute can be defined as the deviation begin time of the first deviation control cycle. Afterward, around 81^{st} minute of the comparison, it is found that the first environment parameter relative extreme value Pe1 (i.e. the first relative humidity relative extreme value) is 18.9. Thus, the 81^{st} minute can be defined as a maximum deviation time of the first deviation control cycle. In this period, after the chamber door 12 is closed, the sensed relative humidity parameters begin to decrease until 118^{th} minute of the comparison which time the sensed relative humidity parameters begin to be lower than the upper control boundary value UCB and back to the relative humidity control range. Thus, the 118^{th} minute can be defined as a return control time of the first deviation control cycle.

Thereafter, a maximum deviation time difference Ta1 of the first deviation control cycle is found to be 4 minutes by subtracting 77 minutes from 81 minutes, and a return time difference Tb1 of the first deviation control cycle is found to be 37 minutes by subtracting 81 minutes from 118 minutes.

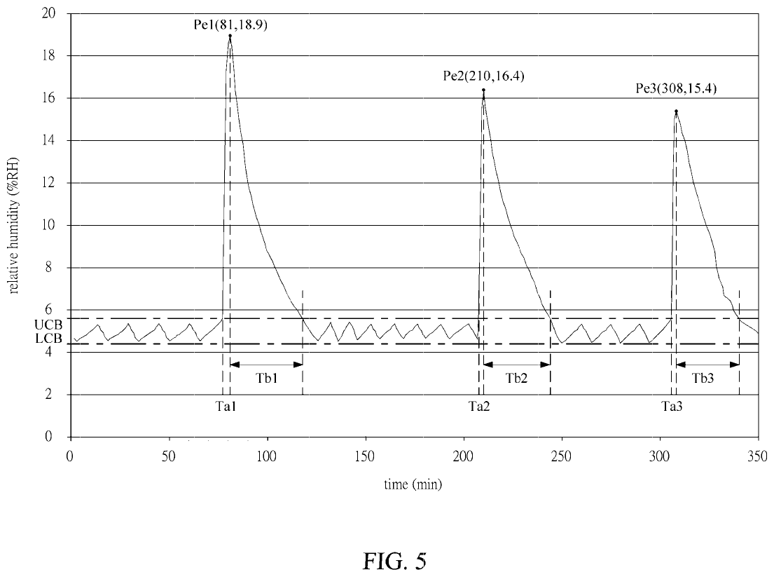

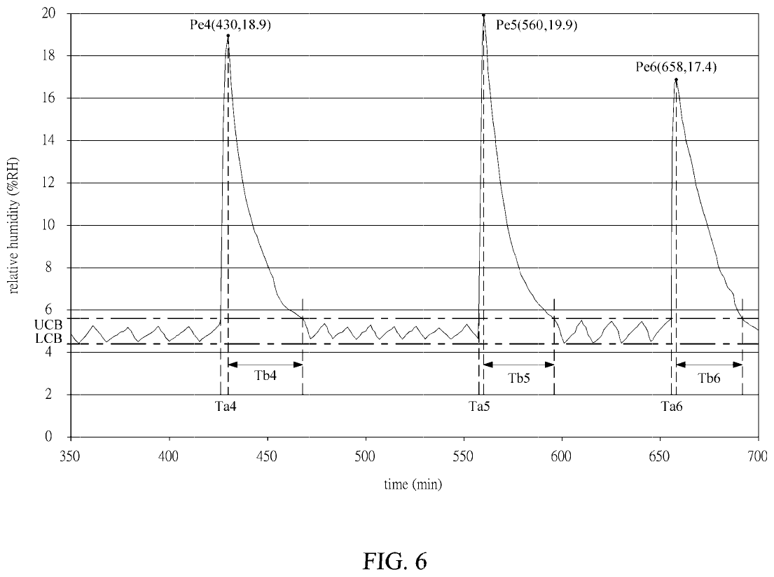

Please refer to FIG. 1, FIG. 5 and FIG. 6, wherein FIG. 5 is a graph showing relative humidity versus time of the first statistic computing period, and FIG. 6 is a graph showing relative humidity versus time of the second statistic computing period. The aging index computing module 42 receives m maximum deviation time differences and m return time differences corresponding to m deviation control cycles included in a first statistic computing period, receives n maximum deviation time differences and n return time differences corresponding to n deviation control cycles included in a most recently completed r^{th} statistic computing period, and when the sensed environment parameters of each of the deviation control cycles fall into the control range again, computes an initial exhaust rate of modulation capacity according to a first function, computes a current exhaust rate of modulation capacity according to a second function, and computes an aging index representing an aging status according to a third function.

The first function is ERmci=(Σᵢ₌₁^{m}Tbi)/(Σᵢ₌₁^{m}Tai). The second function is ERmcc=(Σⱼ₌₁ⁿTbi)/(Σⱼ₌₁ⁿTai). The third function is AI=(ERmcc−ERmci)/ERmci·100%.

Wherein, ERmci is corresponding to the initial exhaust rate of modulation capacity of the first statistic computing period; Tai is the maximum deviation time difference of i^{th} deviation control cycle in the first statistic computing period; Tbi is the return time difference of the i^{th} deviation control cycle in the first statistic computing period; ERmcc is corresponding to the current exhaust rate of modulation capacity of the r^{th} statistic computing period; Taj is the maximum deviation time difference of j^{th} deviation control cycle in the r^{th} statistic computing period; Tbj is the return time difference of the j^{th} deviation control cycle in the r^{th} statistic computing period; and AI is the aging index, the environment parameter includes relative humidity and oxygen concentration, and r, m, n, i, and j are natural numbers, wherein j is greater than or equal to 2.

In the present embodiment, two statistic computing periods have completed currently. The aging index computing module 42 may receive 3 maximum deviation time differences Ta1, Ta2, and Ta3 (which are 4 minutes, 3 minutes, and 3 minutes respectively), and 3 return time differences Tb1, Tb2, and Tb3 (which are 37 minutes, 34 minutes, and 32 minutes respectively), corresponding to 3 deviation control cycles included in the first statistic computing period, and receive 3 maximum deviation time differences Ta4, Ta5, and Ta6 (which are 4 minutes, 3 minutes, and 3 minutes respectively), and 3 return time differences Tb4, Tb5, and Tb6 (which are 38 minutes, 36 minutes, and 33 minutes respectively), corresponding to 3 deviation control cycles included in the most recently completed second statistic computing period. Thus, r=2, m=3 and n=3.

Due to the purpose of continuous numbering, the maximum deviation time difference Taj (from j=1 to n, wherein n=3) of the second statistic computing period should be corresponding to the maximum deviation time differences Ta4, Ta5, and Ta6, respectively, and the return time difference Tbj (from j=1 to n, wherein n=3) of the second statistic computing period should be corresponding to the return time differences Tb4, Tb5, and Tb6, respectively.

According to the first function, it is found that ERmci=(37+34+32)/(4+3+3)=10.3, which indicates that the initial exhaust rate of modulation capacity of the first statistic computing period is 10.3. According to the second function, it is found that ERmcc=(38+36+33)/(4+3+3)=10.7, which indicates that the current exhaust rate of modulation capacity of the second statistic computing period is 10.7. Thereafter, by using the third function, it is found that AI=(10.7−10.3)/10.3·100%=3.9%, which indicates that the aging index is 3.9%.

The display 5 can be a built-in touch display disposed on the conditioning chamber device 1, an eight-segment display, or an external display, and is communicated with the computing device 4 for receiving and displaying the aging index. The near end operator 300 close to the conditioning chamber device 1 may estimate the residual modulation capacity of the environment parameter adjusting module 13 and the time left for maintaining normal operation by checking the aging index to access sufficient response time to prepare troubleshooting actions, such as making an appointment to perform maintenance or replace consumables by oneself or outsourcing.

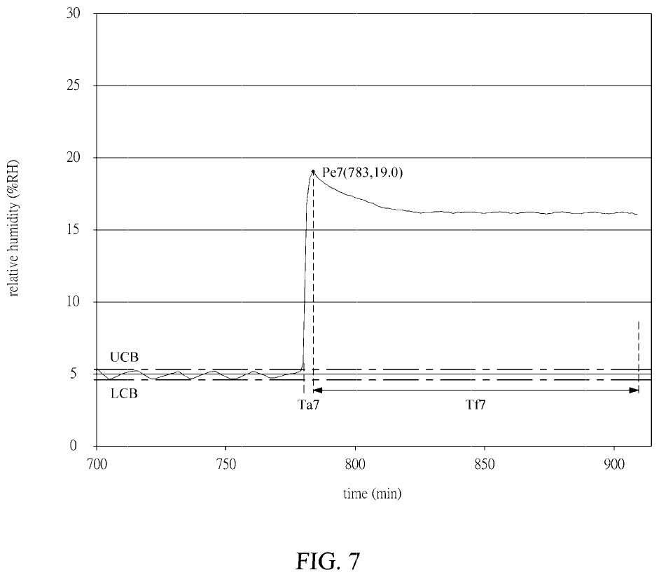

Please refer to FIG. 1, FIG. 5, FIG. 6, and FIG. 7, wherein FIG. 7 is a graph showing relative humidity versus time when an overtime deviation failure status occurs after six deviation control cycles. In addition to the computation of the aging index, the computing device 4 can also be used to analyze whether the conditioning chamber device 1 is in a failure status. The determinable failure status includes the overtime deviation failure status and the severe deviation failure status. For the overtime deviation failure status, the computing device 4 may set an allowable return time ratio either by default or manually setting, and uses the first failure determination module 43 for determining the conditioning chamber device 1 is in the overtime deviation failure status when an overtime deviation failure condition is satisfied, so as to output an overtime deviation failure signal S1.

The overtime deviation failure condition is (Tfk)/(Tak)≥Kar.

Wherein, Tak is the maximum deviation time difference of k^{th} deviation control cycle after finishing k−1^{th} deviation control cycle; Tfk is a continuous deviation time difference corresponding to the sensed environment parameters continuously staying outside the control range after the maximum deviation time difference of the kth deviation control cycle; and Kar is the allowable return time ratio, and K is a natural number.

In the present embodiment, the allowable return time ratio Kar is set to 40. After 2 statistic computing periods passing by, totally 6 deviation control cycles have passed, and the 7^{th} maximum deviation time difference Ta7 happens in the time period from the 780^{th} minute to the 783^{rd} minute is 3 minutes. After the 7^{th} maximum deviation time difference Ta7 and until the 910^{th} minute, the sensed environment parameters continuously stay outside the control range. Thus, in this situation, k=7, and the 7^{th} continuous deviation time difference Tf7 after the 7^{th} maximum deviation time difference Ta7 is 127 minutes. Because 127/3=42.3 that is greater than the allowable return time ratio (Kar=40), which indicates that the conditioning chamber device 1 cannot have the relative humidity fall in the relative humidity control range from the lower control boundary value LCB (4.6% RH) to the upper control boundary value UCB (5.3% RH), and thus the overtime deviation failure status is determined.

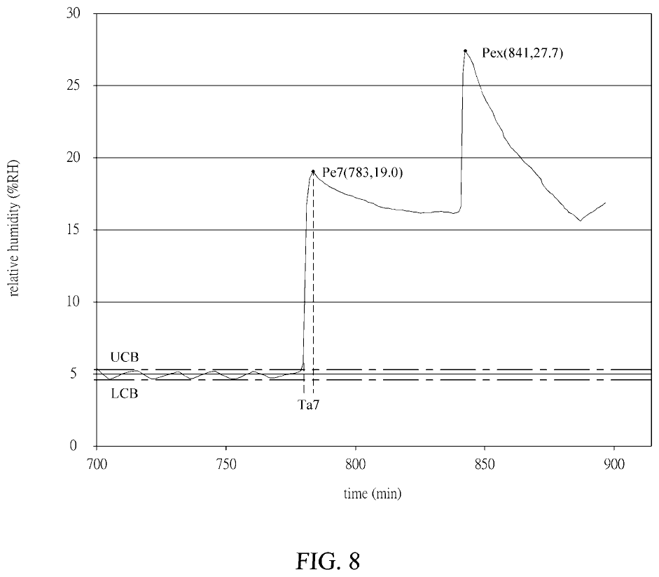

Please refer to FIG. 1, FIG. 5, FIG. 6, and FIG. 8, wherein FIG. 8 is a graph showing relative humidity versus time when a severe deviation failure status occurs after six deviation control cycles. For the severe deviation failure status, the computing device 4 may set an allowable deviation amplification either by default or manually setting. The second failure determination module 44 includes an average extreme value computing unit 441 and a comparison determination unit 442.

The average extreme value computing unit 441 is used for computing, after s deviation control cycles, an average environment parameter relative extreme value of the s deviation control cycles according to a fourth function. The comparison determination unit 442 is used for determining the conditioning chamber device 1 is in a severe deviation failure status when a severe deviation failure condition is satisfied, so as to output a severe deviation failure signal S2.

The fourth function is Pea=(Σₜ₌₁^{s}Pet)/s.

The severe deviation failure condition is |Pex−Pea|≥Kad, wherein, Pea is the average environment parameter relative extreme value; Pet is t^{th} environment parameter relative extreme value; Pex is an intensified deviation extreme value generated from the sensed environment parameters after reaching s+1^{th} environment parameter relative extreme value but is more deviated from the control range than the s+1^{th} environment parameter relative extreme value before returning to the control range; and Kad is the allowable deviation amplification, wherein s and t are natural numbers, and s is greater than or equal to 2.

In the present embodiment, the allowable deviation amplification Kad is 10% RH. After 2 statistic computing periods passing by, totally 6 deviation control cycles have passed, and the 7^{th} environment parameter relative extreme value Pe7 generated at the 783^{rd} minute (i.e. the 7^{th} relative humidity relative extreme value) is 19.0% RH. Before returning to the control range, although the overtime deviation failure status does not happen, an intensified deviation extreme value (i.e. the intensified deviation relative humidity extreme value) Pex=37.7% RH is generated, which is more deviated from the control range than the 7^{th} environment parameter relative extreme value. In this situation, s is equal to 6.

According to FIG. 5 and FIG. 6, it is known that the environment parameter relative extreme values (i.e. the relative humidity relative extreme values) corresponding to the 6 deviation control cycles are 18.9% RH, 16.4% RH, 15.4% RH, 18.9% RH, 19.0% RH, and 17.4% RH.

It is noted that (18.9% RH+16.4% RH+15.4% RH+18.9% RH+19.0% RH+17.4% RH)/6=17.67% RH, which indicates that the average environment parameter relative extreme value Pea of the 6 completed deviation control cycles is 17.67%. After the 7^{th} environment parameter relative extreme value Pe7 (i.e. the 7^{th} relative humidity relative extreme value Pe7 is 19.0% RH) is generated but before returning to the control range, an intensified deviation extreme value (i.e. the intensified deviation relative humidity extreme value) Pex=37.7% RH is generated, which is more deviated from the control range than the 7^{th} environment parameter relative extreme value (Pe7=19.0% RH).

Because |37.7% RH−17.67% RH|≥10% RH the severe deviation failure condition is satisfied, and thus it is determined that the conditioning chamber device 1 is under the severe deviation failure status.

The setting operation interface 6 may be a touch panel disposed on the conditioning chamber device 1, an operation panel, or operation buttons. The setting operation interface is communicated with the environment parameter adjusting module 13, the timing type environment parameter sensor 2 and the computing device 4 for setting the sensing period, the control range and the statistic computing period. In addition, the setting operation interface 6 may also be used for setting the allowable return time ratio and the allowable deviation amplification. Thereby, a near end operator 300 close to the conditioning chamber device 1 may transmit the setting-related parameters to the environment parameter adjusting module 13, the timing type environment parameter sensor 2, and the computing device 4 through operating the setting operation interfaced 6.

The alarm device 7 is communicated with the computing device 4 for delivering a failure alarm signal AS when receiving the overtime deviation failure signal S1 or the severe deviation failure signal S2. Preferably, the alarm device 7 may include an alarm light 71 and/or an alarm buzzer 72 for generating an optical alarm signal and/or an audio alarm signal as the failure alarm signal AS.

The remote monitoring device 8 can be a cell phone, a personal computer, a desktop computer, a tablet, or an industrial computer, and is communicated with the computing device for transmitting a failure notification message to notify a remote operator 400 operating the remote monitoring device 8 when receiving the overtime deviation failure signal S1 or the severe deviation failure signal S2.

In conclusion, the anti-oxidation conditioning system 100 with a function for automatically displaying aging status provided in the present invention uses the current exhaust rate of modulation capacity of the anti-oxidation conditioning system operating the most recently completed r^{th} statistic computing period and the initial exhaust rate of modulation capacity of the anti-oxidation conditioning system completing the first statistic computing period to execute the comparison computation so as to access the aging status of the anti-oxidation conditioning system 100 after operating the most recently completed statistic computing period in comparison with that during the first statistic computing period, and presents the aging status on the display 5 disposed on the conditioning chamber device 1 in the form of aging index for a near end operator 300 operating the conditioning chamber device 1 such that the near end operator 300 can handle the aging condition of the anti-oxidation conditioning system 100 at any time.

By using the aforementioned technologies, the near end operator 300 may estimate residual modulation capacity and time left for maintaining normal operation, and access sufficient response time to prepare troubleshooting actions, such as making an appointment to perform maintenance or replace consumables by oneself or outsourcing.

From the above description, through the practice of the present invention, it is not needed to occupy a large storage space for storing maintenance components or consumables as well as to prepare a large number of standby maintenance personnel for troubleshooting, such that it can be further ensured that the antioxidant environment control system 100 operates with reasonable performance and energy cost. There is no doubt that in compared with the prior art, the present invention can achieve the effects such as reducing the storage cost of maintenance components or consumables, reducing maintenance labor costs, reducing system operation costs, and fulfilling social responsibilities of “energy saving and carbon reduction”.

The foregoing descriptions are merely preferred embodiments of this disclosure, and do not constitute any limitation on this disclosure. Any form of variation such as equivalent replacement or modification made to the technical means and technical content disclosed in this disclosure without departing from the scope of the technical means of this disclosure is the content of the technical means of this disclosure and still falls within the protection scope of this disclosure.

1. An anti-oxidation conditioning system with a function of automatically displaying aging status comprising:
a conditioning chamber device, having an anti-oxidation conditioning space for storing at least one object, for adjusting an environment parameter of the anti-oxidation conditioning space during operation to keep the environment parameter within a control range;
at least one timing type environment parameter sensor, disposed in the anti-oxidation conditioning space, wherein each one of the at least one timing type environment parameter sensor senses a plurality of sensed environment parameters in a plurality of sensing times defined by a sensing period respectively when the conditioning chamber device is operated;
a data storage device, communicated with the at least one timing type environment parameter sensor, for receiving and storing the plurality of sensing times and the plurality of corresponding sensed environment parameters;
a computing device, having a computing program installed therein, communicated with the data storage device for retrieving the plurality of sensing times and the plurality of corresponding sensed environment parameters from the data storage device, set with the control range and a statistic computing period, and after executing the computing program, the computing device comprising:
an environment parameter comparison module, used for retrieving a deviation begin time and a maximum deviation time from the plurality of sensing times to access a maximum deviation time difference when determining that the plurality of sensed environment parameters begins to leave the control range and reaches a corresponding extreme value by sequential comparison, and retrieving a return time from the plurality of sensing times to access a return time difference when determining that the plurality of sensed environment parameters falls in the control range again from the corresponding extreme value by sequential comparison, wherein the process for accessing the maximum deviation time difference and the process for accessing the return time difference are defined as a deviation control cycle; and
an aging index computing module, receiving m maximum deviation time differences and m return time differences corresponding to m deviation control cycles included in a first statistic computing period, receiving n maximum deviation time differences and n return time differences corresponding to n deviation control cycles included in a most recently completed r^{h} statistic computing period, and when the plurality of sensed environment parameters of each of the deviation control cycles falls into the control range again, computing an initial exhaust rate of modulation capacity according to a first function, computing a current exhaust rate of modulation capacity according to a second function, and computing an aging index representing an aging status according to a third function; and
a display, disposed on the conditioning chamber device, and communicated with the computing device for receiving and displaying the aging index;
wherein, the first function is: ERmci=(Σᵢ₌₁^{m}Tbi)/(Σᵢ₌₁^{m}Tai), the second function is: ERmcc=(Σⱼ₌₁ⁿTbj)/(Σⱼ₌₁ⁿTaj), and the third function is: AI=(ERmcc−ERmci)/ERmci)·100%;
wherein, ERmci is corresponding to the initial exhaust rate of modulation capacity of the first statistic computing period; Tai is the maximum deviation time difference of i^{th} deviation control cycle in the first statistic computing period; Tbi is the return time difference of the i^{th} deviation control cycle in the first statistic computing period; ERmcc is corresponding to the current exhaust rate of modulation capacity of the r^{th} statistic computing period; Taj is the maximum deviation time difference of j^{th} deviation control cycle in the r^{th} statistic computing period; Tbj is the return time difference of the j^{th} deviation control cycle in the r^{th} statistic computing period; and AI is the aging index, the environment parameter includes relative humidity and oxygen concentration, and r, m, n, i, and j are natural numbers, wherein j is greater than or equal to 2.

2. The anti-oxidation conditioning system with a function of automatically displaying aging status of claim 1, wherein after executing the computing program, the computing device further comprises a first failure determination module and is set with an allowable return time ratio, wherein the first failure determination module is utilized for determining the conditioning chamber device is in an overtime deviation failure status when an overtime deviation failure condition is satisfied, so as to output an overtime deviation failure signal wherein, the overtime deviation failure condition is (Tfk)/(Tak)≥Kar; wherein, Tak is the maximum deviation time difference of k^{th} deviation control cycle after finishing k−1^{th} deviation control cycle; Tfk is a continuous deviation time difference corresponding to the sensed environment parameters continuously staying outside the control range after the maximum deviation time difference of the k^{th} deviation control cycle; and Kar is the allowable return time ratio, and K is a natural number.

3. The anti-oxidation conditioning system with a function of automatically displaying aging status of claim 1, wherein after executing the computing program, the computing device further comprises a second failure determination module and is set with an allowable deviation amplification, wherein the second failure determination module comprises:
an average extreme value computing unit, for computing, after s deviation control cycles, an average environment parameter relative extreme value of the s deviation control cycles according to a fourth function; and
a comparison determination unit, for determining the conditioning chamber device is in a severe deviation failure status when a severe deviation failure condition is satisfied, so as to output a severe deviation failure signal;
wherein, the fourth function is Pea=(Σₜ₌₁^{s}Pet)/s;
wherein, the severe deviation failure condition is |Pex−Pea|≥Kad;
wherein, Pea is the average environment parameter relative extreme value; Pet is t^{th} environment parameter relative extreme value; Pex is an intensified deviation extreme value generated from the sensed environment parameters after reaching s+1^{th} environment parameter relative extreme value but is more deviated from the control range than the s+1^{th} environment parameter relative extreme value before returning to the control range; and Kad is the allowable deviation amplification, wherein s and t are natural numbers, and s is greater than or equal to 2.

4. The anti-oxidation conditioning system with a function of automatically displaying aging status of claim 2, further comprising an alarm device, the alarm device is communicated with the computing device for delivering a failure alarm signal when receiving the overtime deviation failure signal or the severe deviation failure signal.

5. The anti-oxidation conditioning system with a function of automatically displaying aging status of claim 4, wherein the alarm device further comprises an alarm light or an alarm buzzer for generating an optical alarm signal or an audio alarm signal as the failure alarm signal.

6. The anti-oxidation conditioning system with a function of automatically displaying aging status of claim 2, further comprising a remote monitoring device, the remote monitoring device is communicated with the computing device for transmitting a failure notification message to notify a remote operator operating the remote monitoring device when receiving the overtime deviation failure signal or the severe deviation failure signal.

7. The anti-oxidation conditioning system with a function of automatically displaying aging status of claim 6, wherein the remote monitoring device is a cell phone, a personal computer, a desktop computer, a tablet, or an industrial computer.

8. The anti-oxidation conditioning system with a function of automatically displaying aging status of claim 1, further comprising a setting operation interface, wherein the setting operation interface is communicated with the at least one timing type environment parameter sensor and the computing device for setting the sensing period, the control range and the statistic computing period.

9. The anti-oxidation conditioning system with a function of automatically displaying aging status of claim 1, wherein the at least one timing type environment parameter sensor is a timing type relative humidity sensor or a timing type oxygen concentration sensor.

10. The anti-oxidation conditioning system with a function of automatically displaying aging status of claim 1, wherein the data storage device is a near end data collector or a data storage server.

11. The anti-oxidation conditioning system with a function of automatically displaying aging status of claim 1, wherein the computing device is an embedded computer of the conditioning chamber device, an industrial computer, a personal computer, a laptop computer, or a computer server.
